(19) United States
(12) Patent Application Publication
(10) Pub. No.: US 2023/0302391 A1
(43) Pub. Date: Sep. 28, 2023

(54) FILTER ELEMENT AND FILTER DEVICE

(71) Applicant: MANN+HUMMEL GmbH, Ludwigsburg (DE)

(72) Inventors: Klaus GEHWOLF, Mamming (DE); Tobias TANDETZKI, Vilsbiburg (DE); Anton RABANTER, Oberhausen (DE)

(21) Appl. No.: 18/328,173

(22) Filed: Jun. 2, 2023

Related U.S. Application Data
(63) Continuation of application No. PCT/EP2021/083921, filed on Dec. 2, 2021.

(30) Foreign Application Priority Data
Dec. 3, 2020 (DE) 102020132167.8

(51) Int. Cl. B01D 46/52; B01D 46/10

(52) U.S. Cl. CPC B01D 46/522; B01D 46/10; B01D 2275/206

(57) ABSTRACT

A filter element has a filter medium with a plurality of successive folds arranged in a longitudinal direction from a first transverse side of the filter medium to a second transverse side of the filter medium. A fold height of the successive folds continuously decreases in the longitudinal direction. A fold width of the successive folds continuously decreases in the longitudinal direction. A filter device such as an air filter is provided with such a filter element.

### CROSS-REFERENCE TO RELATED APPLICATIONS

This application is a continuation application of international application No. PCT/EP2021/083921 having an international filing date of 2 Dec. 2021 and designating the United States, the international application claiming a priority date of 3 Dec. 2020 based on prior filed German patent application No. 10 2020 132 167.8, the entire contents of the aforesaid international application and the aforesaid German patent application being incorporated herein by reference.

### BACKGROUND OF THE INVENTION

The invention concerns a filter element with a filter medium which comprises a plurality of successive folds in a longitudinal direction from a first transverse side to a second transverse side.

Such filter elements are known in the prior art.

In U.S. Pat. No. 5,897,776 A, an air filter with a filter medium is disclosed, wherein the filter medium in a central region comprises a larger filter surface than in a rim region. In an embodiment, more folds can be arranged in the central region than in the rim region for this purpose. A similar filter element is disclosed in JPH1176729A. A second embodiment of the air filter of U.S. Pat. No. 5,897,776 A provides that a fold height in the central region is larger than in the rim region.

CN 201752600 U discloses an inner pressure filter with a circular filter element of folded filter paper. Successive folds of the filter element comprise repeated increasing and decreasing heights and spacings.

It is an object of the invention to improve the filtration performance to be realized in a limited installation space.

### SUMMARY OF THE INVENTION

This object is solved by a filter element with a filter medium which comprises a plurality of successive folds in a longitudinal direction from a first transverse side to a second transverse side, wherein a height of the folds continuously decreases in the longitudinal direction, and wherein a width of the folds continuously decreases in the longitudinal direction.

This object is further solved by a filter device, preferably air filter, comprising a filter housing and a filter element according to the invention.

Preferred embodiments are disclosed in the dependent claims and the description.

According to the invention, a filter element with a filter medium is provided. The filter medium comprises a plurality of successive folds in a longitudinal direction. The longitudinal direction extends from a first to a second transverse side of the filter element. The folds are delimited, on the one hand, by first fold edges and, on the other hand, by second fold edges. A fold is understood presently in particular as a V-shaped section of the filter medium. A fold can thus extend from a first fold edge across a second fold edge to a further first fold edge. Alternatively, a fold can extend from a second fold edge across a first fold edge to a further second fold edge. The fold edges extend in principle transversely, preferably perpendicularly, in relation to the longitudinal direction. In particular, the fold edges can extend parallel to the transverse sides. At the two transverse sides and at longitudinal sides, the filter element can comprise a frame. The filter medium can be embedded in the frame. In particular, the frame can seal open end faces of the folds. The filter element can be an air filter element.

According to the invention, a height of the folds continuously decreases in the longitudinal direction. The height of the folds describes in particular a spacing between the first and the second fold edges of the respective folds. The height of the folds can be measured perpendicularly to the longitudinal direction. The height of a fold can be determined as an average value of the distance of the first or second fold edge, which delimits the fold at one side, and the two second or first fold edges which delimit the fold at the other side.

A continuous decrease of the height of the folds is understood in particular such that no fold which in the longitudinal direction is positioned farther to the front (closer to the second transverse side) is higher than a fold which is positioned in the longitudinal direction farther to the rear (closer to the first transverse side). It should be mentioned that regions with folds of the same height may exist. The continuous decrease of the height of the folds further requires that, with the exception of a group of folds that are last in the longitudinal direction, a fold with a reduced height and positioned farther to the front in relation to the longitudinal direction exists for each fold. The group of the last folds in the longitudinal direction can comprise a single fold or a plurality of folds.

In other words, the height of a fold which is positioned farther in front in the longitudinal direction is maximally as large as the height of each one of the folds which are positioned farther to the rear in longitudinal direction. Folds positioned farthest to the rear in the longitudinal direction comprise the largest height; folds which are positioned farthest to the front in the longitudinal direction comprise the smallest height. The smallest height is smaller than the largest height.

Further in accordance with the invention, a width of the folds—measured in the longitudinal direction—decreases continuously in the longitudinal direction. The width of the folds can also be referred to as fold division. The width of the folds or the fold division can be measured between first or second fold edges at which immediately succeeding folds adjoin each other.

A depth of the filter element that is measured parallel to the fold edges can be constant or changing.

Due to the changing height of the folds, the filter element can also be used in installation spaces with a complex shape and maximally utilize the available installation space. In that the width of the folds is changing with the height of the folds, an advantageous ratio of its dimensions relative to each other can be selected for each fold. This can improve the flow through a filter device with the filter element. In particular, for high fold heights and filter media with minimal permeability, a pressure loss above the filter element can be reduced due to the configuration of the filter element in accordance with the invention. Furthermore, a dust absorption capacity of the filter element can be increased due to the design according to the invention.

As a function of the degree of separation determined by the employed medium, of the filtration conditions, e.g., the filtration speed, and of the existing installation space, the fold heights and fold divisions of the filter element are matched to each other in such a way that a pressure loss as minimal as possible and a dust absorption capacity as large as possible will result.

Particularly good results in relation to the dust absorption capacity and pressure loss for the use in an air filter for filtration of intake air of an internal combustion engine or cathode air of a fuel cell can be obtained when the filter element has the following parameters: For a fold height of 400 mm to 500 mm, the fold division amounts to 3.7 mm to 6.0 mm; for a fold height of 275 mm to 400 mm, the fold division amounts to 3.3 mm to 4.5 mm; for a fold height of 175 mm to 275 mm, the fold division amounts to 3.0 mm to 3.7 mm; and for a fold height of 75 mm to 175 mm, the fold division amounts to 2.5 mm to 3.3 mm.

For interior filters, in particular building ventilation filters, or gas turbine filters, the following parameters are particularly advantageous: For a fold height of 400 mm to 500 mm, the fold division amounts to 5.0 mm to 10.0 mm; for a fold height of 275 mm to 400 mm, the fold division amounts to 4.0 mm to 8.0 mm; for a fold height of 175 mm to 275 mm, the fold division amounts to 4.0 mm to 6.0 mm; and for a fold height of 75 mm to 175 mm, the fold division amounts to 3.5 mm to 5.0 mm.

In a particularly preferred embodiment, it is provided that the width of the folds in the longitudinal direction decreases segmentally. In other words, in several segments of the filter element, the width of the folds, in other words the fold division, is respectively of the same size. In the sequence of the segments along the longitudinal axis, the width of the folds decreases. Across the longitudinal direction, the width of the folds thus describes a stepped progression. Such a filter element can be manufactured economically. For example, the filter element comprises three or four segments with different fold divisions. In particular, the filter element comprises a steadily decreasing fold height with values from a range between 500 mm and 75 mm and comprises three or four segments within which the fold division is identical, respectively, and selected from the aforementioned intervals in such a way that the fold division decreases in longitudinal direction.

Alternatively, the width of the folds in the longitudinal direction can decrease steadily at least in regions. It can be provided in this context that, in individual segments along the longitudinal direction, the folds are embodied with the same width within the respective segments. In the other regions, the width of the folds then decreases steadily. Preferably, the width of the folds however continuously decreases steadily from the first transverse side to the second transverse side. A steady decrease is understood in this respect such that the width of a fold which is positioned father to the front in the longitudinal direction (closer to the second transverse side) is smaller than the width of the fold which is positioned immediately behind in the longitudinal direction (closer to the first transverse side).

The height of the folds can decrease segmentally. In other words, in a plurality of segments of the filter element, the height of the folds is respectively of the same size. In the sequence of the segments along the longitudinal axis, the height of the folds decreases. Across the longitudinal direction, the height of the folds describes thus a stepped progression. The segments of folds of same height can coincide with segments of folds of the same width.

Alternatively, the height of the folds in the longitudinal direction can decrease steadily at least in regions. It can be provided in this context that, in individual segments along the longitudinal direction, the folds are embodied with the same height within the respective segment. In the other regions, the height of the folds then decreases steadily. Preferably, the height of the folds however continuously decreases steadily from the first transverse side to the second transverse side. A steady decrease is understood in this respect such that the height of a fold which is positioned father to the front in the longitudinal direction (closer to the second transverse side) is smaller than the height of the fold which is positioned immediately behind in the longitudinal direction (closer to the first transverse side).

Advantageously, the width and the height of the folds have constant ratio relative to each other, respectively. In other words, the quotient of its height and its width is of the same size for each of the folds. For maximum deviations of up to 20%, in particular up to 10%, of the size ratios of individual folds from an average value of the quotient, the ratios can be considered to be of the same size. In this embodiment, the same geometric conditions of the folds—optimal for the filtration—are established everywhere across the length of the filter element.

First fold edges of the folds can extend in a common first plane.

Preferably, all first fold edges of the filter element extend in the first plane. This can simplify manufacture and handling of the filter element.

Furthermore, the second fold edges of the folds can extend in a second plane. Preferably, all second fold edges of the filter element extend in the second plane. The first plane and the second plane are slanted relative to each other so that the height of the folds in the longitudinal direction decreases.

First and/or second fold edges of the folds can extend parallel to each other. This simplifies the manufacture. Preferably, all first and second fold edges extend parallel to each other.

The filter medium is based advantageously on cellulose. For example, the filter medium is comprised of cellulose fibers reinforced with synthetic resin.

The material thickness of the filter medium is preferably between 0.25 mm and 1.5 mm.

The permeability according to DIN EN ISO 9237 of the filter medium lies preferably between 20 l/m²/s and 400 l/m²/s at 200 Pa, further preferred between 80 l/m²/s and 200 l/m²/s at 200 Pa.

The filter medium is flowed through advantageously at 1 cm/s to 20 cm/s, in particular 2 cm/s to 6 cm/s.

The scope of the present invention includes furthermore a filter device with a filter housing and a filter element in accordance with the invention as described above. The filter device is preferably an air filter. The filter housing comprises typically an inflow opening and an outflow opening for the fluid to be filtered. The filter element can be arranged in the housing in order to separate a raw side correlated with the inflow opening from a clean side correlated with the outflow opening of the filter device.

The filter device can be used for filtration of intake air in internal combustion engines or of cathode air in fuel cells, in particular for vehicles. However, it can also be a ventilation filter or a gas turbine filter.

### BRIEF DESCRIPTION OF THE DRAWINGS

Further features and advantages of the invention result from the following detailed description of embodiments of the invention, from the claims as well as with the aid of the Figures of the drawing showing details according to the invention. The aforementioned and still further explained features can be realized individually by themselves or several in arbitrary expedient combinations in variants of the invention. The features shown in the drawing are illustrated in such a way that the particularities according to the invention can be made clearly visible.

FIG. 1 shows a filter element according to the invention in which in a longitudinal direction a height of folds of a filter medium decreases steadily and a width of the folds decreases segmentally, in a schematic cross section view.

FIG. 2 shows a filter element according to the invention in which in a longitudinal direction a height and a width of folds of a filter medium decrease steadily, in a schematic cross section view.

FIG. 3 shows a filter device according to the invention with a filter element according to the invention arranged in a filter housing, in a schematic cross section view.

### DESCRIPTION OF PREFERRED EMBODIMENTS

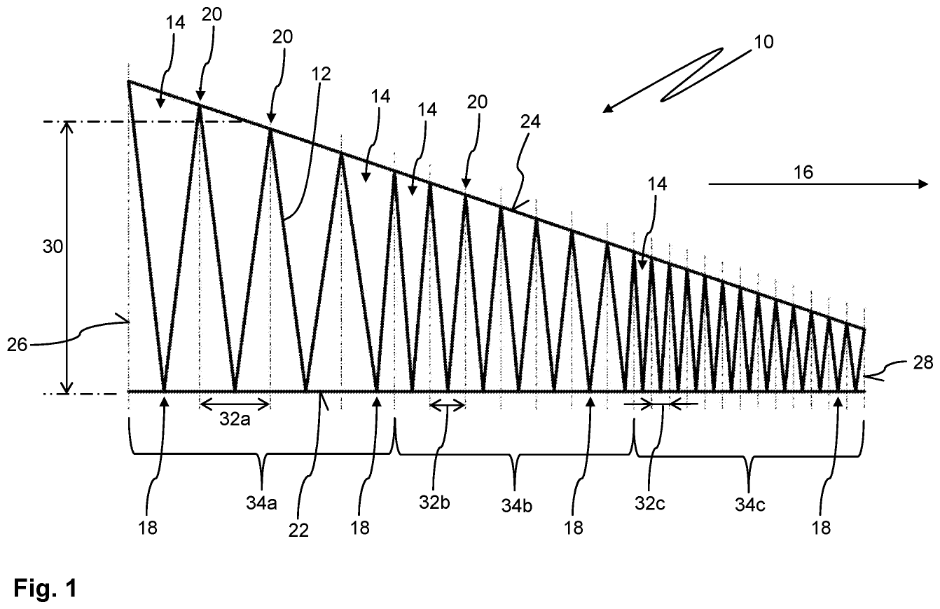

FIG. 1 shows a filter element 10. The filter element 10 comprises a folded filter medium 12. The filter medium 12 can be held in a frame of the filter element 10, not illustrated in detail, wherein the frame can carry a circumferentially extending seal or can be itself embodied as such. The filter element 10 is configured as a so-called flat filter element, i.e., it extends between a raw side and an oppositely positioned clean side without enclosing an intermediately positioned hollow space that can be flowed through. The filter element 10 is substantially rectangular but in principle can have any other cross section shape.

The filter medium 12 comprises a plurality of folds 14. The folds 14 are arranged successively in a longitudinal direction 16. The folds 14 are delimited, on the one hand (in FIG. 1 at the bottom), by first fold edges 18. On the other hand (in FIG. 1 at the top), the folds 14 are delimited by second fold edges 20. Neighboring folds 14 adjoin each other at the second fold edges 20. Here, the first fold edges 18 extend all in a first plane 22. The second fold edges 20 can also extend all in a second plane 24. The first and the second fold edges 18, 20 can extend respectively parallel to each other and in particular perpendicularly to the longitudinal direction 16. In FIG. 1, the fold edges 18, 20 extend perpendicularly to the drawing plane. The filter medium 12 extends in the longitudinal direction 16 from a first transverse side 26 to a second transverse side 28.

The folds 14 of the filter medium 12 each have a different height 30. The height 30 can be measured as the (average) distance of the first fold edges 18 from the second fold edges 20 of a respective fold 14 perpendicularly to the longitudinal direction and perpendicularly to the fold edges 18, 20. The height 30 of every fold 14 arranged closer to the second transverse side 28 is here smaller than a height 30 of every fold 14 arranged closer to the first transverse side 26. Folds 14 arranged closer to the first transverse side 26 have thus a larger height 30 than folds 14 arranged closer to the second transverse side 28. In other words, the height 30 of the folds 14 continuously decreases steadily in the longitudinal direction 16 from the first transverse side 26 to the second transverse side 28.

The folds 14 of the filter medium 12 have different widths 32a, 32b, 32c. The filter medium 12 comprises here a plurality of segments 34a, 34b, 34c in which the widths 32a, 32b, 32c of the folds 14 are of the same size, respectively. In other words, all folds 14 of one of the segments 34a, 34b, 34c each have the same width 32a, 32b or 32c. The folds 14 of a segment 34a, 34b arranged closer to the first transverse side 26 comprise a larger width 32a, 32b than the folds 14 of the segments 34b, 34c arranged closer to the second transverse side 28. In other words, the width 32a, 32b, 32c of the folds 14 decreases segmentally in the longitudinal direction 16. In this way, the width 32a, 32b, 32c of the folds 14 decreases from the first transverse side 26 continuously to the second transverse side 28.

Example 1: For an air filter element for filtration of intake air for an internal combustion engine with a media permeability of 80 l/m2/s to 250 l/m2/s and a filtration speed of 2 cm/s-8 cm/s, the following values have been found to be particularly advantageous:

Advantageously, the fold height in the first segment 34a decreases from approximately 500 mm to approximately 400 mm and the fold division amounts to a constant value between 3.7 mm and 6.0 mm, for example, 4.5 mm. In the second segment 34b, the fold height decreases from 400 mm to 275 mm and the fold division amounts to 3.3 mm to 4.5 mm, for example, 3.7 mm. In the third segment 34c, the fold height lies between 275 mm and 175 mm for a fold division between 3.0 mm and 3.7 mm, for example, 3.3 mm.

The third segment 34c can be adjoined by a fourth segment—not illustrated—in which the fold heights from approximately 175 mm on decrease, preferably to a height of approximately 75 mm, and which has a fold division between 2.5 mm and 3.3 mm.

Example 2: For an air filter element for HVAC applications with a media permeability of 25 l/m2/s and a filtration speed of 1 cm/s-3 cm/s, the fold division in the first segment 34a lies between 5.0 mm and 10.0 mm, for example, at 6 mm, in the second segment 34b between 4.0 mm and 8.0 mm, and in the third segment 34c between 4.0 mm and 6.0 mm, while the fold height, as in the first embodiment, in the first segment 34a lies between 400 mm and 500 mm, in the second segment 34b between 275 mm and 400 mm, and in the third segment 34c between 275 mm and 175 mm. In a fourth segment, not illustrated, with a fold height between 75 mm and 175 mm, the fold division amounts to 3.5 mm to 5.0 mm.

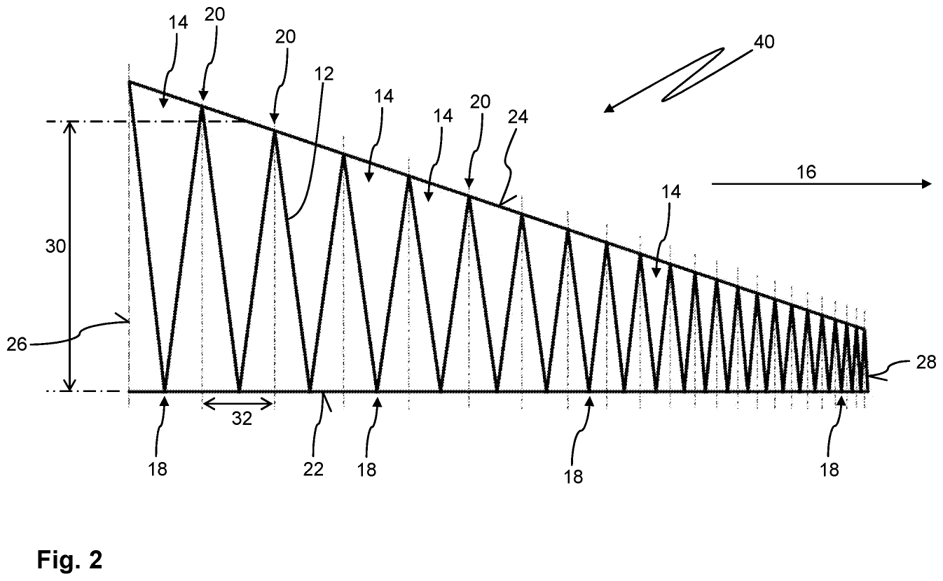

FIG. 2 shows a further filter element 40. The filter element 40 is constructed similarly to the filter element 10 of FIG. 1. In the following, primarily the differences are described. In other respects, reference is being had to the prior description.

In the filter element 40—as in the filter element 10 of FIG. 1—a height 30 of folds 14 of a filter medium 12 continuously decreases steadily in a longitudinal direction 16. From a first transverse side 26 to a second transverse side 28, the height 30 of the folds 14 decreases continuously.

In contrast to the filter element 10 of FIG. 1, it is provided in the filter element 40 illustrated in FIG. 2 that a width 32 of the folds 14 along the longitudinal direction 16 decreases steadily. The width 32 of each fold 14 arranged closer to the second transverse side 28 is in this context smaller than a width 32 of each fold 14 arranged closer to the first transverse side 26. Folds 14 arranged closer to the first transverse side 26 have thus a greater width 32 than folds 14 arranged closer to the second transverse side 28. In this way, the width 32 of the folds 14 decreases continuously from the first transverse side 26 to the second transverse side 28. In this context, a ratio of the respective height 30 and of the respective width 32 can have the same value for each one of the folds 14.

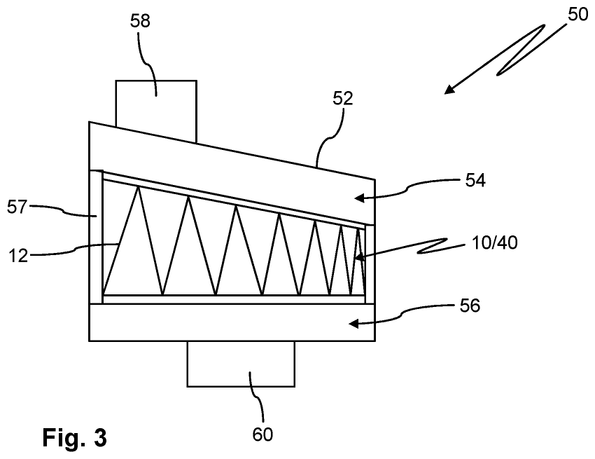

FIG. 3 shows a filter device 50. The filter device 50 is embodied here as an air filter. The filter device 50 can be used for filtering combustion air for an internal combustion engine, for filtering cathode air for a fuel cell or as an interior air filter in a motor vehicle.

The filter device 50 comprises a filter housing 52. In the filter housing 52, a filter element is arranged, for example, the filter element 10 of FIG. 1 or the filter element 40 of FIG. 2. The filter element 10/40 separates in the filter housing 52 a raw side 54 from a clean side 56. A circumferentially extending frame 57 of the filter element 10/40 can seal the filter medium 12 in relation to the filter housing 52. The raw side 54 communicates with an inflow opening 58. The clean side 56 communicates with an outflow opening 60. In operation of the filter device 50, air to be filtered flows through the inflow opening 58 into the raw side 54. The air passes then through the filter element 10/40, wherein dirt particles are retained in the filter medium 12, so that filtered air reaches the clean side 56. From the clean side 56, the filtered air flows through the outflow opening 60 out of the filter housing 52.

In summarizing, the invention concerns a filter element with a folded filter medium. The filter element can be a flat filter element. A height and a width (division) of folds of the filter medium is variable. In a length direction, the height as well as the width of the folds can decrease continuously. Folds with a larger width have a greater height than folds with a smaller width.

### LIST OF REFERENCE CHARACTERS

filter element 10, 40
filter medium 12
folds 14
longitudinal direction 16
first fold edges 18
second fold edges 20
first plane 22
second plane 24
first transverse side 26
second transverse side 28
height 30 of the folds 14
width 32, 32a, 32b, 32c of the folds 14
segments 34a, 34b, 34c
filter device 50
filter housing 52
raw side 54
clean side 56
frame 57
inflow opening 58
outflow opening 60

What is claimed is:

1. A filter element comprising:
a filter medium comprising a plurality of successive folds arranged in a longitudinal direction from a first transverse side of the filter medium to a second transverse side of the filter medium;
wherein a fold height of the successive folds continuously decreases in the longitudinal direction; and
wherein a fold width of the successive folds continuously decreases in the longitudinal direction.

2. The filter element according to claim 1, wherein the fold width of the successive folds decreases segmentally in the longitudinal direction.

3. The filter element according to claim 2, wherein the fold height of the successive folds decreases segmentally in the longitudinal direction.

4. The filter element according to claim 1, wherein the fold height of the successive folds decreases segmentally in the longitudinal direction.

5. The filter element according to claim 1, wherein the fold height of the successive folds decreases steadily in the longitudinal direction at least in regions of the filter medium.

6. The filter element according to claim 5, wherein the fold height of the successive folds decreases steadily continuously from the first transverse side to the second transverse side.

7. The filter element according to claim 1, wherein first fold edges of the successive folds extend in a first plane.

8. The filter element according to claim 7, wherein second fold edges of the successive folds extend in a second plane.

9. The filter element according to claim 8, wherein the first fold edges and the second fold edges extend parallel to each other.

10. The filter element according to claim 8, wherein the second fold edges extend parallel to each other.

11. The filter element according to claim 7, wherein the first fold edges extend parallel to each other.

12. The filter element according to claim 1, wherein a fold division of the successive folds amounts to 3.7 mm to 6 mm when the fold height amounts to 400 mm to 500 mm.

13. The filter element according to claim 1, wherein a fold division of the successive folds amounts to 3.3 mm to 4.5 mm when the fold height amounts to 275 mm to 400 mm.

14. The filter element according to claim 1, wherein a fold division of the successive folds amounts to 3.0 mm to 3.7 mm when the fold height amounts to 175 mm to 275 mm.

15. The filter element according to claim 1, wherein a fold division of the successive folds amounts to 2.5 mm to 3.3 mm when the fold height amounts to 75 mm to 175 mm.

16. The filter element according to claim 1, wherein a fold division of the successive folds amounts to 5.0 mm to 10.0 mm when the fold height amounts to 400 mm to 500 mm.

17. The filter element according to claim 1, wherein a fold division of the successive folds amounts to 4.0 mm to 8.0 mm when the fold height amounts to 275 mm to 400 mm.

18. The filter element according to claim 1, wherein a fold division of the successive folds amounts to 4.0 mm to 6.1 mm when the fold height amounts to 175 mm to 275 mm.

19. The filter element according to claim 1, wherein a fold division of the successive folds amounts to 3.5 mm to 5.0 mm when the fold height amounts to 75 mm to 175 mm.

20. A filter device comprising a filter housing and a filter element according to claim 1.
